(19) United States
(12) Patent Application Publication
(10) Pub. No.: US 2025/0162381 A1
(43) Pub. Date: May 22, 2025

(54) AIR CONDITIONING SYSTEM, MOTOR VEHICLE, AND ASSOCIATED OPERATING METHOD

(71) Applicant: MAHLE INTERNATIONAL GMBH, Stuttgart (DE)

(72) Inventor: Walter WOLF, Oppenweiler-Zell (DE)

(21) Appl. No.: 18/950,388

(22) Filed: Nov. 18, 2024

(30) Foreign Application Priority Data
Nov. 20, 2023 (DE) 102023211497.6

(51) Int. Cl. B60H 1/24

(52) U.S. Cl. CPC B60H 1/242

(57) ABSTRACT

An air conditioning system for heating and cooling intake air for a passenger compartment in a motor vehicle is provided, containing at least one cooler for cooling intake air, at least one heater for heating intake air, at least one fresh air intake for supplying fresh air from the environment to the cooler and/or heater, at least one discharge air passage for removing discharge air from the passenger compartment into the environment, and at least one heat exchanger, incorporated in the discharge air passage and the fresh air intake, which is configured to exchange heat between the fresh air and the discharge air.

### CROSS-REFERENCE TO RELATED APPLICATIONS

This application claims priority from German Patent Application No. DE 10 2023 211 497.6, filed on Nov. 20, 2023, the entirety of which is hereby fully incorporated by reference herein.

The present invention relates to an air conditioning system for heating and cooling the air entering the passenger compartment of a motor vehicle according to the preamble of claim 1. It also relates to a vehicle equipped with such an air conditioning system. Furthermore, the invention relates to a method for operating an air conditioning system in a vehicle.

This type of air conditioning system is disclosed in DE 10 2014 012 706 A1, and contains a cooler for cooling intake air, a heater for heating intake air, a fresh air intake for supplying fresh air to the cooler and/or heater, a discharge air passage for discharging air from passenger compartment into the environment, and a heat exchanger connected to the discharge air passage and fresh air intake, configured to exchange heat between the fresh air and the discharge air. To be able to suction off discharge air from the passenger compartment, conventional air conditioning systems normally have a fan incorporated in the discharge air passage that propels this air.

This type of fan consumes energy, which has a negative impact on the range of an electric vehicle in particular.

The present invention is concerned with the problem of creating a better, or at least different design for an air conditioning system like that described above, a motor vehicle equipped therewith, and an operating method, which consumes less energy, that is also compact.

This problem is solved by the subject matter of the independent claims. Advantageous embodiments are the subject matter of the dependent claims.

The invention is based on the general idea of using a jet pump for removing discharge air, which uses air streams flowing against and/or around, or partially through the moving vehicle as its power source. These jet pumps have no moving parts, are typically durable, and relatively compact, thus requiring relatively little space. By using air streams to power the jet pump, energy obtained from the movement of the vehicle is exploited, eliminating the need for electricity to remove discharge air from the vehicle. This air conditioning system therefore consumes less energy from other power sources, and can therefore be operated particularly efficiently.

In detail, it is proposed that the air conditioning system obtained with the invention be equipped with at least one jet pump, which has a vacuum connection, a propellant intake, and a mixture outlet. The vacuum connection is upstream of the heat exchanger in the discharge air passage, and connected thereto. The propellant intake is connected to an air stream intake for the air conditioning system that conducts the air streams striking, surrounding, or passing through the moving vehicle from the environment to the propellant intake. The mixture outlet is connected to the discharge air passage such that a mixture of discharge air and air stream is discharged into the environment. The jet pump is therefore incorporated in the mixture outlet and the discharge air passage and connected to the air stream intake by the propellant intake in order to propel the discharge air. An air stream is generated when the vehicle is moving, which is conveyed to the propellant intake through the air stream intake. When the air stream flows through the jet pump, a vacuum is generated at the vacuum connection, which vacuums off discharge air. This discharge air is mixed with the air stream in the jet pump, which then exits the discharge air passage through the mixture outlet into the environment.

Because of the jet pump, the fan in the discharge air passage can be significantly smaller. Conceivably, this fan can even be eliminated entirely.

An embodiment in which the heat exchanger block is upstream of the cooler and/or the heater in the fresh air intake is preferred. Heat exchange then takes place between the discharge air and intake air, upstream of where the intake air is heated or cooled. By this means, the discharge air can be used for a preliminary heating or cooling of the fresh air, such that less energy is needed for the final heating or cooling thereof. The fresh air in this context is that air taken from the environment and supplied to the passenger compartment. The fresh air is thus conditioned to obtain the intake air for the vehicle interior. The actual air in the intake air is the same air as that in the fresh air, but at a different temperature and/or humidity.

An embodiment in which the air stream in the air stream intake is propelled exclusively by the movement of the motor vehicle is particularly advantageous. This eliminates the need for a fan in the air stream intake.

When a jet pump is used to propel the discharge air, the fan for propelling the discharge air can be smaller. It is even conceivable to entirely eliminate such a fan. Potentially, the discharge air can be propelled entirely by the jet pump into the discharge air passage.

An embodiment in which the jet pump is a vacuum ejector that produces a vacuum by means of the Venturi effect is particularly advantageous. This type of pump is extremely efficient, in particular when used in gas flows.

In the present context, “configuration” means the same as “design” and/or “arrangement,” such that the formulation “configured such” means the same as “designed such” and/or “arranged such.”

In an advantageous embodiment, the Venturi pump can contain a converging nozzle, which is connected axially to the propellant intake. The propellant, i.e. the air stream, is thus accelerated in the nozzle. The Venturi pump can have an annular vacuum chamber coaxially surrounding the nozzle, connected radially to the vacuum connection. The discharge air is removed through this vacuum chamber when the Venturi pump is in use. The Venturi pump can also have a divergent mixing chamber, which is connected axially to the nozzle and is coaxial to the nozzle and the vacuum chamber, and leads to the mixture outlet. The discharge air is mixed with the air stream in the mixing chamber. The air flow is also slowed in the mixing chamber. The Venturi pump can also contain an annular gap that interconnects an axial nozzle outlet, an axial mixing chamber outlet, which is coaxial to the nozzle outlet, and an annular radial vacuum chamber outlet, which is placed axially between the nozzle outlet and the mixing chamber outlet. The nozzle, mixing chamber, and vacuum chamber are therefore interconnected by this annular gap. The Venturi pump creates a vacuum in the annular gap, which spreads to the vacuum connection through the vacuum chamber, such that the discharge air can be suctioned off.

The fresh air intake can contain at least one fan for propelling the fresh air in an advantageous embodiment. By this means, the fresh air can be drawn in from anywhere on the vehicle, or the amount of incoming air can be increased by dynamic pressure.

In another advantageous embodiment, the air conditioning system can contain an intake for recirculating air, which suctions in air in the passenger compartment that is then added to the fresh air, or intake air, upstream or downstream of the cooler and/or heater. This recirculating air can also be used to heat or cool the intake air, in order to reduce power consumption.

In another advantageous embodiment, the air stream intake has a control unit for controlling the volume of the air stream. This control unit can have at least one shutter in the cross section of the air stream intake, which can be adjusted in order to alter the cross section of the air stream intake. The control unit can be placed near the air stream intake. This control unit can be placed in particular in the vehicle. It can be formed by a shutter on the grill. By way of example, it can be formed by a grill shutter. Because the volume and speed of the air stream depend on the current speed of the vehicle, the volume of the air stream in the air stream intake depends on the current speed of the vehicle. The control unit can control the volume of the air stream in the air stream intake to prevent an undesired suctioning off of discharge air higher speeds. The control unit can also be placed downstream of the grill, between the front of the vehicle and the passenger compartment air intake.

The motor vehicle obtained with the invention has a passenger compartment and an air conditioning system of the type described above.

The air stream intake can be placed in the front, bottom, side, A pillar, B pillar, C pillar, or D pillar of the vehicle. The air stream intake can also contain a channel for guiding the air stream, which connects this intake with the propellant intake. The jet pump can therefore be placed practically anywhere in the vehicle where it makes sense.

The outlet in the discharge air passage can be in the rear, bottom, side, A pillar, B pillar, C pillar, or D pillar of the vehicle. This discharge air passage can also have a channel for guiding the discharge air, which connects it to the mixture outlet. The jet pump can therefore be placed practically anywhere in the vehicle where it makes sense.

The vehicle can contain a diffusor that is open toward the exterior. The discharge air passage can be connected to this diffusor at the outlet end. The outlet end of the discharge air passage can also be placed underneath the floor in the vehicle.

The motor vehicle can be a passenger automobile, truck, bus, or train.

With the method for operating an air conditioning system for heating and cooling air entering a passenger compartment in a vehicle obtained with the invention, discharge air is suctioned out of the passenger compartment by a jet pump and discharged into the environment, in that the jet pump is powered by the air stream flowing against and around the vehicle when it is in motion.

Heat between the discharge air and fresh air from the vehicle's environment can be conveyed toward the passenger compartment in an advantageous embodiment. Depending on the difference in temperature between the vehicle's environment and the passenger compartment, heat in the discharge air can be used to heat the fresh air, or the fresh air can be cooled by transferring heat to the discharge air.

Other important features and advantages of the invention can be derived from the dependent claims, drawings, and the descriptions of the drawings.

It is understood that the features specified above and explained below can be used not only in the given combinations, but also in other combinations or in and of themselves, without abandoning the scope of the invention defined by the claims. Components of a superordinate unit, e.g. a feature, device or assembly, specified herein, which are indicated separately, can form separate elements or components of the unit in question, or integral parts of this unit, even if the drawings indicate otherwise.

Preferred exemplary embodiments are shown in the drawings and shall be explained in greater detail below, in which the same reference symbols are used for the same, similar, or functionally identical components.

Therein, schematically:

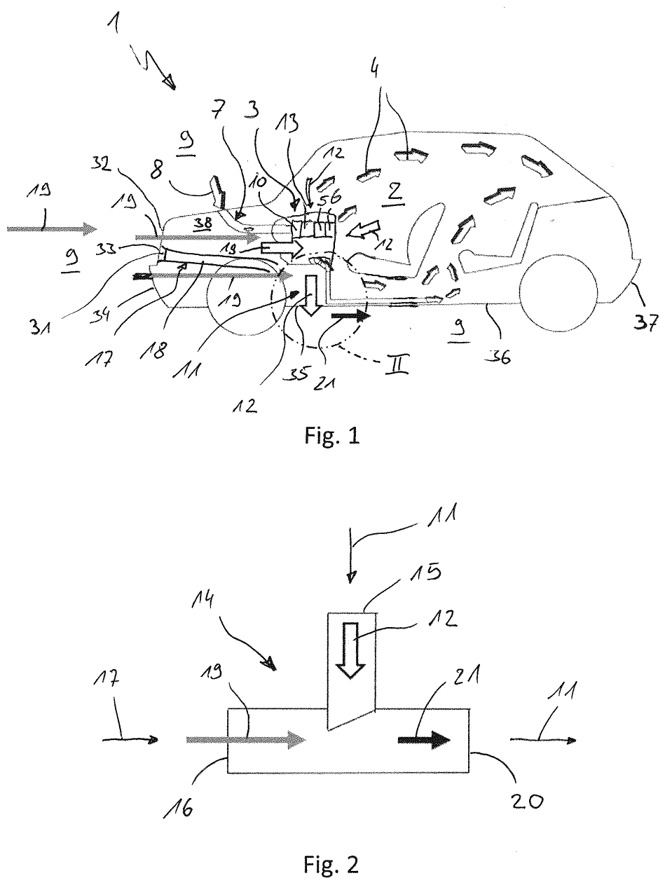

FIG. 1 shows a highly simplified illustration of a motor vehicle that has an air conditioning system,

FIG. 2 shows a highly simplified illustration of a detail II from FIG. 1, containing a jet pump, and

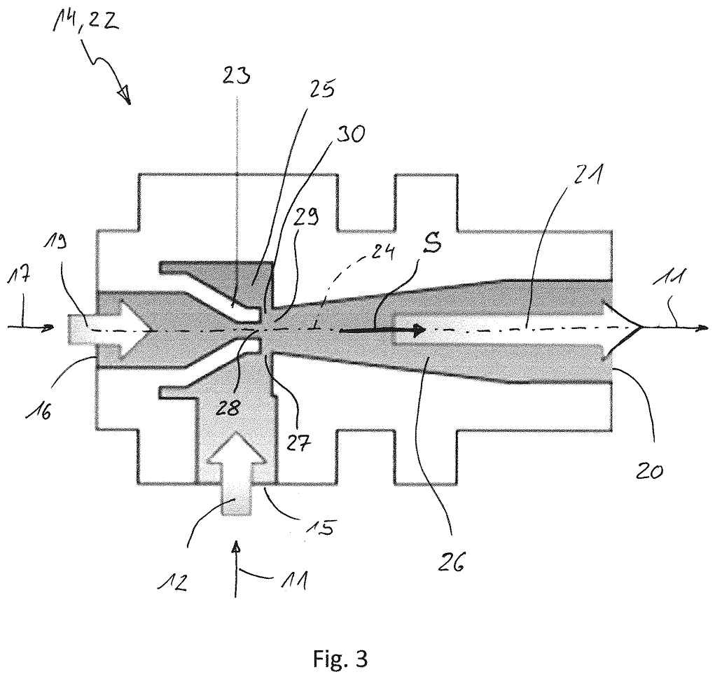

FIG. 3 shows an enlargement of a sectional view of the jet pump according to one embodiment.

FIG. 1 shows a motor vehicle 1 in the form of a passenger automobile, which has a passenger compartment 2 and an air conditioning system 3. The air conditioning system 3 is used to heat and cool intake air 4, as indicated by the arrows in FIG. 1. The intake air 4 is supplied to the passenger compartment 2. The air conditioning system 3 contains at least one cooler 5 for cooling the intake air 4 and at least one heater 6 for heating the intake air 4. The air conditioning system 3 also contains an supply line 7 for the fresh air 8, indicated by an arrow in FIG. 1, which comes from the vehicle's environment 9, conducting it to the cooler 5 and/or heater 6. The fresh air intake 7 can have a dedicated fan 10, which propels the fresh air 8.

The air conditioning system 3 also has at least one discharge air passage 11, with which discharge air 12 is conducted out of the passenger compartment 2 and into the vehicle's environment 9. The discharge air 12 is indicated in FIGS. 1 to 3 by arrows. The air conditioning system 3 also has a heat exchanger 13, which is incorporated in the discharge air passage 11 and the fresh air intake 7, and is configured such that heat exchange can take place between the fresh air 8 and discharge air 12.

As shown in FIGS. 2 and 3, the air conditioning system 13 can have at least one jet pump 14 for propelling the discharge air 12. The jet pump 14 has a vacuum connection 15 connected to the discharge air passage 11 downstream of the heat exchanger 13. The discharge air passage 11 is indicated by arrows in FIGS. 2 and 3.

The jet pump 14 also has a propellant intake 16 connected to an air stream intake 17 for the air conditioning system 3. The air stream intake 17 is indicated by an arrow in FIGS. 2 and 3, and formed by a channel 18 in FIG. 1. The air stream intake 17 can conduct air streams 19, indicated by arrows in FIGS. 1 to 3, from the vehicle's environment 9 to the propellant intake 16. The air streams 19 are formed by the movement of the vehicle 1, represented by the air flowing against and/or around the moving vehicle 1, as well as partially through it, depending on the design of the vehicle.

The jet pump 14 also has a mixture outlet 20, which is connected to the discharge air passage 11 such that the discharge air passage 11 discharges a mixture of 21 of discharge air 12 and air stream 19 into the vehicle's environment 9. The mixture 11 is also indicated by arrows in FIGS. 1 to 3.

The heat exchanger 13 is preferably incorporated in the fresh air intake 7, upstream of the cooler 5 and/or the heater 6.

The air stream 19 can be propelled in the air stream intake 17 exclusively by the motion of the vehicle 1. The discharge air 12 can be propelled in the discharge air passage 11 exclusively by the jet pump 14. A fan can also be placed in the discharge air passage 11, which is not shown in the drawings. This fan can propel the discharge air 12 when the vehicle 1 is not moving, or moving slowly.

As shown in FIG. 3, the jet pump 14 is preferably a Venturi pump 22. The Venturi pump 22 has a convergent nozzle 23, which is connected axially to the propellant intake 16. The axial direction is defined by the longitudinal axis of the 24 of the Venturi pump 22. The axial direction is the main direction S in which the air stream 19 flows through the Venturi pump 22, indicated by an arrow in FIG. 3. The mixture 21 also flows through the Venturi pump 22 in this direction S. The nozzle 23 converges in the main flow direction S through the Venturi pump 22.

The Venturi pump 22 also has an annular vacuum chamber 25, which encompasses the nozzle 23 coaxially, and is connected radially to the vacuum connection 15. The Venturi pump 22 also has a divergent mixing chamber 26, which is connected axially to the nozzle 23 and is also coaxial to the nozzle 23 and the vacuum chamber 25, and leads to the mixture outlet 20. The mixing chamber 26 diverges in the main flow direction S for the Venturi pump 22.

The Venturi pump 22 also has an annular gap 27, which interconnects an axial nozzle outlet 28, an axial mixing chamber intake 29, which is coaxial to the nozzle outlet 28, and an annular radial vacuum chamber outlet 30, which is between the nozzle outlet 28 and the mixing chamber intake 29.

The air stream intake 17 shown in FIG. 1 can have a dedicated control unit 31 with which the volume of the air stream 19 in the air stream intake 17 is controlled. By way of example, the control unit 31 can have at least one shutter in the cross section of the air stream intake 17, which can be adjusted to alter the size of the cross section through which air can flow. In FIG. 1, the control unit 31 is near the grill 32 on the vehicle 1. Accordingly, the intake 33 for the air stream intake 17 is at the front 34 of the vehicle. The channel 18 connects the intake 33 to the propellant intake 16. An outlet 35 for the discharge air passage 11 is formed in the vehicle's floor 36, such that the mixture 21 is discharged into the vehicle's environment 9 through the floor 36. Both the intake 33 for the air stream intake 17 and the outlet for the discharge air passage 11 can be placed basically anywhere in the vehicle 1. By way of example, the intake 33 and/or outlet 35 could be on the side, A pillar, B pillar, C pillar, D pillar, or rear 37 of the vehicle.

While the vehicle 1 is in motion, discharge air 12 is suctioned out of the passenger compartment 2 by the jet pump 14 and conveyed into the vehicle's environment 9. The jet pump 14 is powered by the air stream 19 flowing against and around the vehicle 1 when it is in motion. FIG. 1 also shows that the air stream 19 can also flow through the grill 32 in the front 38 of the vehicle 1, and into the air stream intake 17 there. Heat exchange also takes place between the discharge air 12 and the fresh air 8, to precool the fresh air 8 before it reaches the cooler 5 and heater 6, where it is then cooled before being introduced into the passenger compartment 2.

The specification can be readily understood with reference to the following Numbered Paragraphs:
Numbered Paragraph 1. An air conditioning system (3) for heating and cooling intake air (4) for a passenger compartment (2) in a motor vehicle (1), containing
   at least one cooler (5) for cooling intake air (4),
   at least one heater (6) for heating intake air (4),
   at least one fresh air intake (7) for supplying fresh air (8) from the environment (9) to the cooler (5) and/or heater (6),
   at least one discharge air passage (11) for removing discharge air (12) from the passenger compartment (2) into the environment (9), and
   at least one heat exchanger (13), incorporated in the discharge air passage (11) and the fresh air intake (7), and configured to exchange heat between the fresh air (8) and the discharge air (12),
      characterized in that the air conditioning system (3) also contains at least one jet pump (14), which has
   a vacuum connection (15) connected to the discharge air passage (11) downstream of the heat exchanger (13),
   a propellant intake (16) connected to an air stream intake (17), which conducts the air stream (19) toward, around, and/or at least partially through the motor vehicle (1) to the propellant intake (16), and
   a mixture outlet (20) connected to the discharge air passage (11) such that a mixture (21) of discharge air (12) and air stream (19) is discharged into the vehicle's environment (9).
Numbered Paragraph 2. The air conditioning system (3) according to Numbered Paragraph 1, characterized in that the heat exchanger (13) is incorporated in the fresh air intake (7) upstream of the cooler (5) and/or heater (6).
Numbered Paragraph 3. The air conditioning system (3) according to Numbered Paragraph 1 or 2, characterized in that the air stream (19) is propelled in the air stream intake (17) exclusively by the motion of the vehicle (1).
Numbered Paragraph 4. The air conditioning system (3) according to any of the preceding Numbered Paragraphs, characterized in that the jet pump (14) is a Venturi pump (22).
Numbered Paragraph 5. The air conditioning system (3) according to Numbered Paragraph 4, characterized in that the Venturi pump (22) has
   a convergent nozzle (23), which is connected axially to the propellant intake (16),
   an annular vacuum chamber (25) coaxially encompassing the nozzle (23), which is connected radially to the vacuum connection (15),
   a divergent mixing chamber (26), which is coaxial to the nozzle (23) and the vacuum chamber (25), and leads to the mixture outlet (20),
   an annular gap (27), which interconnects a nozzle outlet (28), a mixing chamber intake (29), which is coaxial to the nozzle outlet (28), and an annular vacuum chamber outlet (30), which is axially between the nozzle outlet (28) and the mixing chamber intake (29).
Numbered Paragraph 6. The air conditioning system (3) according to any of the preceding Numbered Paragraphs, characterized in that the fresh air intake (7) has at least one fan (10) for propelling the fresh air (8).
Numbered Paragraph 7. The air conditioning system (3) according to any of the preceding Numbered Paragraphs, characterized in that the air stream intake (17) has a control unit (31) for controlling the volume of the air stream (19).
Numbered Paragraph 8. A motor vehicle (1), which has
   a passenger compartment (2), and
   an air conditioning system (3) according to any of the preceding Numbered Paragraphs.
Numbered Paragraph 9. The motor vehicle (1) according to Numbered Paragraph 8, characterized in that
   an intake (33) for the air stream intake (17) is placed at the front (34), in the floor (36), on the side, on an A pillar, B pillar, C pillar, or D pillar of the motor vehicle (1),
   the air stream intake (17) has a channel (18) connecting the intake (33) to the propellant intake (15) for the air stream (19).
Numbered Paragraph 10. The motor vehicle (1) according to Numbered Paragraph 8 or 9, characterized in that
   the motor vehicle (1) has a diffusor that is open toward the vehicle's environment (9),
   the discharge air passage (11) is connected to the diffusor where the air exits.
Numbered Paragraph 11. A method for operating an air conditioning system (3) for heating and cooling intake air (4) for a passenger compartment (2) in a motor vehicle (1), in which
   discharge air (12) is suctioned out of the passenger compartment (2) by a jet pump (14), and conveyed toward the vehicle's environment (9),
   the jet pump (14) is powered by air streams (19) flowing toward, around, and/or at least partially through the motor vehicle (1) while it is in motion.
Numbered Paragraph 12. The method according to Numbered Paragraph 11, characterized in that heat is exchanged between the discharge air (12) and the fresh air (8) suctioned into the passenger compartment (2) from the environment (9).

1-12. (canceled)

13. An air conditioning system for heating and cooling intake air for a passenger compartment in a motor vehicle, comprising
at least one cooler for cooling intake air,
at least one heater for heating intake air,
at least one fresh air intake for supplying fresh air from the environment to the cooler and/or heater,
at least one discharge air passage for removing discharge air from the passenger compartment into the environment, and
at least one heat exchanger, incorporated in the discharge air passage and the fresh air intake, and configured to exchange heat between the fresh air and the discharge air,
wherein the air conditioning system further comprises at least one jet pump, the at least one jet pump comprising:
a vacuum connection connected to the discharge air passage downstream of the heat exchanger,
a propellant intake connected to an air stream intake, which conducts the air stream toward, around, and/or at least partially through the motor vehicle to the propellant intake, and
a mixture outlet connected to the discharge air passage such that a mixture of discharge air and air stream is discharged into the vehicle's environment.

14. The air conditioning system according to claim 12, wherein the heat exchanger is disposed in the fresh air intake upstream of the cooler and/or heater.

15. The air conditioning system according to claim 13, wherein the air stream is propelled in the air stream intake exclusively by the motion of the vehicle.

16. The air conditioning system according to claim 13, wherein the jet pump is a Venturi pump.

17. The air conditioning system according to claim 16, wherein the Venturi pump comprises
a convergent nozzle, the convergent nozzle is connected axially to the propellant intake,
an annular vacuum chamber coaxially encompassing the nozzle, the annular vacuum chamber is connected radially to the vacuum connection,
a divergent mixing chamber, the divergent mixing chamber is coaxial to the nozzle and the vacuum chamber, and the divergent mixing chamber leads to the mixture outlet, and
an annular gap, the annular gap interconnects a nozzle outlet, and a mixing chamber intake, the mixing chamber intake is coaxial to the nozzle outlet, the annular gap further interconnects an annular vacuum chamber outlet, the annular vacuum chamber outlet is axially between the nozzle outlet and the mixing chamber intake.

18. The air conditioning system according to claim 13, wherein the fresh air intake comprises at least one fan for propelling the fresh air.

19. The air conditioning system according to claim 13, wherein the air stream intake comprises a control unit for controlling the volume of the air stream.

20. A motor vehicle, comprising:
a passenger compartment, and
an air conditioning system according to claim 13.

21. The motor vehicle according to claim 20, wherein
an intake for the air stream intake is placed at the front, in one of the following positions within the motor vehicle: in the floor, on the side, on an A pillar, on a B pillar, on a C pillar, or on a D pillar of the motor vehicle,
wherein the air stream intake has a channel connecting the intake to the propellant intake for the air stream.

22. The motor vehicle according to claim 20, wherein
the motor vehicle comprises a diffusor that is open toward the vehicle's environment,
the discharge air passage is connected to the diffusor where the air exits.

23. A method for operating an air conditioning system for heating and cooling intake air for a passenger compartment in a motor vehicle, comprising
suctioning discharge air out of the passenger compartment with a jet pump, and conveying the discharge air toward an environment surrounding the vehicle,
the jet pump is powered by air streams flowing toward, around, and/or at least partially through the motor vehicle while the motor vehicle is in motion.

24. The method according to claim 23, wherein heat is exchanged between the discharge air and the fresh air suctioned into the passenger compartment from the environment.
